(19) United States
(12) Patent Application Publication
(10) Pub. No.: US 2026/0220430 A1
(43) Pub. Date: Jul. 30, 2026

(54) ACCELERATING MULTI-VIEW SEARCH WITH DYNAMIC VIEW ROUTING

(71) Applicant: GDM Holding LLC, Mountain View, CA (US)

(72) Inventors: Cho-Jui Hsieh, Los Angeles (CA); Prateek Jain, Bangalore (IN)

(21) Appl. No.: 19/465,980

(22) Filed: Jan. 30, 2026

(30) Foreign Application Priority Data
Jan. 30, 2025 (IN) 202511007741

(51) Int. Cl. G06N 3/045; G06F 18/22; G06F 40/284; G06N 3/048; G06N 3/08

(52) U.S. Cl. CPC G06N 3/045; G06F 18/22; G06F 40/284; G06N 3/048; G06N 3/08

(57) ABSTRACT

Methods, systems, and apparatuses, including computer programs encoded on computer storage media, for selecting relevant documents. A system processes a query using a query encoder neural network to generate query embeddings. A router neural network processes the query embeddings to generate a respective score for each embedding. The system selects a representative query embedding based on the scores and utilizes the representative query embedding and stored document embeddings to generate a relevance score for each of a plurality of documents. The system then selects a subset of the documents as relevant to the query based on the relevance scores.

### BACKGROUND

This specification relates to identifying relevant documents to a query using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that identifies relevant documents to a query.

In particular, the system generates relevance scores for documents by selecting and using a single representative embedding of a set of embeddings associated with a query, instead of using all embeddings associated with the query, to dramatically increase the speed of identifying relevant documents for a query.

Particular embodiments of the subject matter described in this specification can be implemented so as to realize one or more of the following advantages.

The ability to accurately and efficiently retrieve relevant documents for a query from vast repositories of data is crucial for a wide range of applications, including search engines, question answering systems, generative neural network systems, and recommendation systems.

Multi-embedding retrieval techniques offer a powerful solution by representing a query or document using multiple embeddings each and then computing late interactions (i.e., computing similarity scores between all pairs of query embeddings and document embeddings after both the query and document have been independently encoded). An example of such a multi-embedding technique includes ColBERT which leverages these multi-embedding representations of queries and documents to perform fine-grained interactions between query and document embeddings and derive final relevance scores for documents given a query.

While effective, the late interaction mechanism of these multi-embedding retrieval techniques introduces a significant computational bottleneck as it requires pairwise comparisons between all query and document embeddings. This limits scalability, especially for large datasets, and hinders compatibility with efficient Approximate Nearest Neighbor Search (ANNS) methods commonly employed for fast retrieval of documents.

Due to the computational cost of multi-embedding retrieval techniques, it is thus more common to employ single-embedding retrieval techniques. That is, representing the entire query as a single dense vector and the entire document as a single dense vector, allowing the retrieval to be performed as a simple dot product or cosine similarity search in a vector space. But the retrieval accuracy of these single-embedding techniques is often lower compared to multi-embedding techniques. Furthermore, their accuracy at times needs to be addressed by using multi-embedding retrieval approaches for re-ranking a subset of identified documents.

Another technique to ameliorate the computational cost of multi-embedding retrieval techniques is to compress the multiple embeddings into a single representation, for example, by computing the average (mean-pooling) or maximum (max-pooling) of the multiple embeddings associated with the query and document. But these techniques also suffer from inaccurate document retrievals for queries.

This specification describes a system that can address the aforementioned challenges. That is, this specification describes techniques that perform document retrieval by selecting a representative embedding for a set of query embeddings to dramatically reduce computation cost for document retrieval without sacrificing performance. The described techniques include processing the query using a query encoder neural network to generate a plurality of query embeddings for the query and processing the query embeddings using a router neural network to generate a respective score for each query embedding. The described techniques also include selecting a representative query embedding from among the query embeddings using the respective scores and generating a respective relevance score for each of the plurality of documents using the representative query embedding and the respective sets of document embeddings for the plurality of documents. Ultimately, the described techniques include selecting, as relevant documents to the query, a subset of the plurality of documents using the respective relevance scores.

By selecting a representative query embedding from among query embeddings using their respective scores, the described techniques significantly reduce the computational latency and memory bandwidth required for document retrieval for a query while also accurately identifying relevant documents.

Unlike late-interaction techniques that necessitate processing a full interaction between all query embeddings and all document embeddings, the described techniques reduce the retrieval operation to a comparison between a single representative embedding and the document embeddings. As a result, the described techniques improve the computational efficiency of retrieving relevant documents from massive datasets by requiring significantly fewer processor cycles and less retrieval time compared to existing multi-embedding techniques.

By processing the query embeddings using a router neural network to generate a respective score for each query embedding, the described techniques enable dynamic, context-aware query embedding selection rather than static query embedding aggregation. That is, unlike techniques that rely on mean-pooling or max-pooling to compress multiple embeddings into a single representation, which often results in the loss of fine-grained semantic details, the scores generated by the router neural network enable the precise identification and selection of the single query embedding that is most informative for the retrieval task. Consequently, the described techniques achieve the highly accurate document retrieval typically associated with complex multi-embedding retrieval techniques while operating within the stricter storage and processing constraints of efficient single-embedding retrieval techniques.

By generating a respective relevance score for each of the plurality of documents using the representative query embedding and the respective sets of document embeddings for the plurality of documents, the described techniques minimize the memory footprint required for query processing during document retrieval. Because only a single representative embedding needs to be held in active memory, rather than a sequence of embeddings for every token in the query, the described techniques reduce the run-time memory requirements of the retrieval process. Therefore, the described techniques can be deployed on hardware with more constrained memory resources than would be possible with full multi-embedding retrieval techniques.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an information retrieval system.

FIG. 2 is a flow diagram of an example process for selecting relevant documents to a query.

FIG. 3 is a flow diagram of an example process for jointly training a router neural network, query encoder neural network, and document encoder neural network.

FIG. 4 is an example of the performance of the described techniques.

FIG. 5 is an example of the performance of the described techniques.

Like reference numbers and designations in the various drawings indicate like elements.

### DETAILED DESCRIPTION

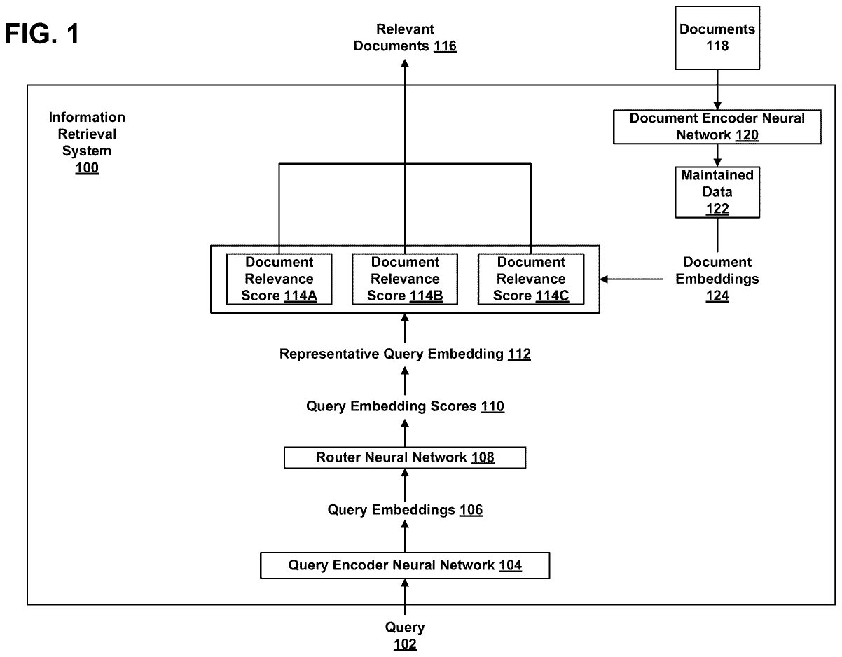

FIG. 1 shows an example information retrieval system 100. The information retrieval system 100 is an example of a system implemented as computer programs on one or more computers in one or more locations, in which the systems, components, and techniques described below can be implemented.

The system 100 is a system that obtains a query 102 and, in response, selects one or more relevant documents 116 from a set of documents 118.

Generally, the query 102 represents the desired document a user seeks. The query 102 can be, e.g., a natural language query, an image query, a multi-modal query, i.e., a query that includes multiple modalities of data, e.g., both text and images or both text and audio, or a query in a structured data format.

Furthermore, the documents 118 can be any appropriate electronic content. For example, the documents 118 can include any of text documents, individual text segments extracted from text documents, images, videos, web pages, audio data, multi-modal documents that include two different modalities of data, e.g., images and text, software applications, and so on.

In some cases, all of the documents 118 are the same type of document while in other implementations different documents 118 are different types of documents.

In particular, the system 100 maintains data 122 associating each of a plurality of documents 118 with a respective set of one or more document embeddings 124 representing the document.

Generally, the system 100 processes each document 118 using a document encoder neural network 120 to generate the respective plurality of document embeddings 124 representing the document.

Generally, the document encoder neural network 120 can have any appropriate architecture in any appropriate configuration that processes a document to generate a plurality of document embeddings for the document, including fully connected layers, convolution layers, recurrent layers, attention-based layers, and so on, as is appropriate.

The system 100 then obtains a query 102. The system 100 can obtain the query 102 from any appropriate source, such as a user or another system.

For example, the system 100 can obtain a query 102 from a user interface on an end-user device (e.g., a search entry entered into a search bar by a user).

As another example, the system 100 can obtain a query 102 from a server running an application (e.g., through an API call initiated by the application).

The system 100 processes the query 102 using a query encoder neural network 104 to generate a plurality of query embeddings 106 for the query.

Generally, the query encoder neural network 104 can have any appropriate architecture in any appropriate configuration that processes a query to generate a plurality of query embeddings for the query, including fully connected layers, convolution layers, recurrent layers, attention-based layers, and so on, as is appropriate.

In some cases, the query encoder neural network 104 and the document encoder neural network 120 are the same neural network (e.g., have the same neural network architecture and the same trained parameter values). In some other cases, the query encoder neural network 104 and the document encoder neural network 120 are different neural networks (e.g., have different neural network architectures and/or different trained parameter values).

In some cases, the query encoder neural network 104 and the document encoder neural network 120 have been trained jointly to generate token vectors in the same embedding space.

In other cases, the query encoder neural network 104 and the document encoder neural network 120 have been trained separately.

Further details of training the query encoder neural network 104 and the document encoder neural network 120 are described below.

The system 100 then processes the query embeddings 106 using a router neural network 108 to generate a respective score for each query embedding (i.e., query embedding scores 110).

Generally, the router neural network 108 can have any appropriate architecture in any appropriate configuration that processes query embeddings 106 to generate respective query embedding scores 110, including fully connected layers, convolution layers, recurrent layers, attention-based layers, and so on, as is appropriate.

For example, the router neural network 108 can include one or more attention layers followed by one or more fully connected layers.

In other examples, the router neural network 108 can be implemented as a multi-layer perceptron (MLP), a one-dimensional convolutional neural network (1D ConvNet), or a recurrent neural network (RNN) that processes the sequence of query embeddings to generate the respective scores.

The query embedding scores 110 can be logits, probabilities, or other types of values.

In some cases, the query router neural network 108 is trained jointly with the query encoder neural network 104.

Prior to using the query encoder neural network 104, document encoder neural network 120, and the router neural network 108, the system 100 or another training system trains these neural networks on a training dataset. Further details of training the query encoder neural network 104, document encoder neural network 120, and the router neural network 108 are described below.

The system 100 selects a representative query embedding 112 from among the query embeddings using the respective scores 110.

In some implementations, the system 100 selects the representative query embedding 112 by applying an argmax function to the scores 110 that identifies the query embedding associated with the largest score 110.

In other implementations, the system 100 selects the representative query embedding 112 by sampling a query embedding from the plurality of query embeddings in accordance with the respective scores 110. For example, the system 100 can treat the respective scores 110 as a probability distribution (e.g., by normalizing the scores using a softmax function) and randomly sample a query embedding based on the probability assigned to each query embedding.

The system 100 generates a respective relevance score 114A-C for each of the plurality of documents using the representative query embedding 112 and the respective sets of document embeddings 124 for the plurality of documents 118.

In some cases, for each document, the system 100 sets the relevance score 114A-C to the greatest similarity measure value between the representative query embedding 112 and any of the document embeddings 124 that are in the set of documents embeddings for the document.

For example, the similarity measure can be the cosine similarity measure. That is, the system 100 computes the cosine similarity measure value between the representative query embedding 112 and each of the document embeddings in the set of document embeddings for the document and identifies the highest respective cosine similarity measure value.

As another example, the similarity measure can be the Euclidean distance, with lower values indicating higher similarity. That is, the system 100 computes the Euclidean distance between the representative query embedding 112 and each of the document embeddings in the set of document embeddings for the document and identifies the highest respective similarity (i.e., the lowest Euclidean distance).

In some cases, instead of generating a respective relevance score 114A-C for each document of the documents 118, the system 100 generates respective relevance score for a set of candidate documents that are “promising”. That is, the system 100 identifies the most similar document embeddings to the representative query embedding 112 and then identifies as candidate documents those documents represented by one or more of the most similar document embeddings.

For example, the system 100 can use software libraries (e.g., Faiss) for advanced indexing of document embeddings, and advance index searching methods using the representative query embedding 112 to efficiently identify the most similar document embeddings 124 and then determine candidate documents.

After the system 100 generates the respective relevance score 114A-C for each of the documents 118, the system 100 selects, as relevant documents 116 to the query 102, a subset of the set of documents 118 using the respective relevance scores 114A-C.

For example, the system 100 can select the documents 118 whose respective relevance scores 114A-C exceed a threshold.

As another example, the system 100 can select the documents 118 whose respective relevance scores are the highest (e.g., the k highest scoring documents).

As described above, prior to using the system 100 to select the documents 118, the system 100 or another training system can train the query encoder neural network 104, the document encoder neural network 120, and the router neural network 108.

Generally, training the query encoder neural network 104, document encoder neural network 120, and the router neural network 108 results in the system 100 learning to generate query embedding scores 110 such that the query embedding that is most relevant for a query is assigned the highest query embedding score.

The training can be performed using a set of training examples. In some implementations, a training example includes a training query, a positive document (also referred to as a target document) that is relevant to the training query, and one or more negative documents (also referred to as non-target documents) that are not relevant to the training query.

Generally, the system 100 updates the trainable parameters of neural networks 104, 120, and 108 by optimizing an objective function. That is, by minimizing the loss over one or more training examples using any of a variety of gradient descent techniques (e.g., batch gradient descent, stochastic gradient descent, or mini-batch gradient descent) that include the use of a backpropagation technique to estimate the gradient of the loss with respect to the trainable parameters, the system 100 updates the trainable parameters of neural networks 104, 120, and 108.

For example, the system 100 optimizes an objective function that encourages the relevance score of the positive document in a training example to be higher than the relevance scores of the one or more negative documents in the training example. In some cases, the objective function is a contrastive loss, such as InfoNCE loss or a categorical cross-entropy loss. For example, the system can apply a softmax function to the relevance scores of the target document and non-target documents to generate a predicted probability distribution, and then minimize the cross-entropy between this predicted distribution and a ground-truth distribution that identifies the target document.

In some cases, to facilitate training, the system 100 uses a Gumbel-Softmax function and a Straight-Through Estimator (STE) to manage the selection of the representative query embedding 112. Because the operation of selecting a representative embedding 112 (e.g., via applying an argmax function to the scores 110, as described above) is non-differentiable, backpropagation cannot pass gradients through the selection of a representative query embedding 112. To address this, the system 100 uses the Gumbel-Softmax trick to approximate the selection sampling in a differentiable way. Furthermore, the system 100 can employ a Straight-Through Estimator, which allows the system 100 to perform a discrete selection (e.g., argmax) during the forward pass to pick the representative embedding 112, while using the continuous Gumbel-Softmax gradients during the backward pass. This enables the system 100 to maintain end-to-end differentiability for the router neural network 108.

The term “Gumbel-softmax function” refers to modifying the query embedding scores 110 described above, after they are initially computed, by generating and adding Gumbel noise to each score 110 and processing the scores using a temperature soft-max function according to, for example, the following equation:

$${y}_{i} = \frac{exp ( ( log ( {α}_{i} ) + {g}_{i} ) / τ )}{{\sum }_{j} exp ( ( log ( {α}_{j} ) + {g}_{j} ) / τ )}$$

where yᵢ corresponds to the updated score for an i-th query embedding, αᵢ represents the initial score 110 for the i-th query embedding, gᵢ represents the Gumbel noise, and τ is a temperature parameter for the temperature softmax function. The system then selects a representative query embedding 112 from among the query embeddings 106 using these new type of respective scores (e.g., the system 100 selects the query embedding associated with the largest yᵢ value).

The term “straight through estimator” (STE) refers to allowing gradients to backpropagate through the Gumbel-softmax function by computing the derivative of the step of selecting a representative query embedding 112 as the derivative of the Gumbel-softmax function. That is, during the forward pass, the system 100 can select the query embedding 106 with the highest score (e.g., as described above), which creates a discrete “hard” choice (i.e., representative query embedding 112). Because the derivative of a discrete choice is undefined, standard gradient descent would fail to update trainable parameters of the router neural network 108 (or the encoder neural networks). To solve this issue, the STE allows the system 100 to use the “hard” selected query embedding for the forward calculation of the loss, but during the backward pass, the system 100 substitutes the gradient of the “hard” selection with the gradient of the differentiable, continuous Gumbel-softmax output. This enables processing of the query 102 to select relevant documents 116 to maintain end-to-end differentiability while also performing discrete selection of a representative query embedding 106.

In some cases, during training, the system 100 incorporates a masking mechanism to regularize the selection of a representative query embedding. That is, the system 100 applies a mask to the query embedding scores 110 after the query embedding scores 110 are computed.

Further details of training the query encoder neural network 104, the document encoder neural network 120, and the router neural network 108 are described below.

While FIG. 1 shows only three document relevance scores 114A-C, in practice the system 100 can include any number of documents, and, therefore any number of documents 118.

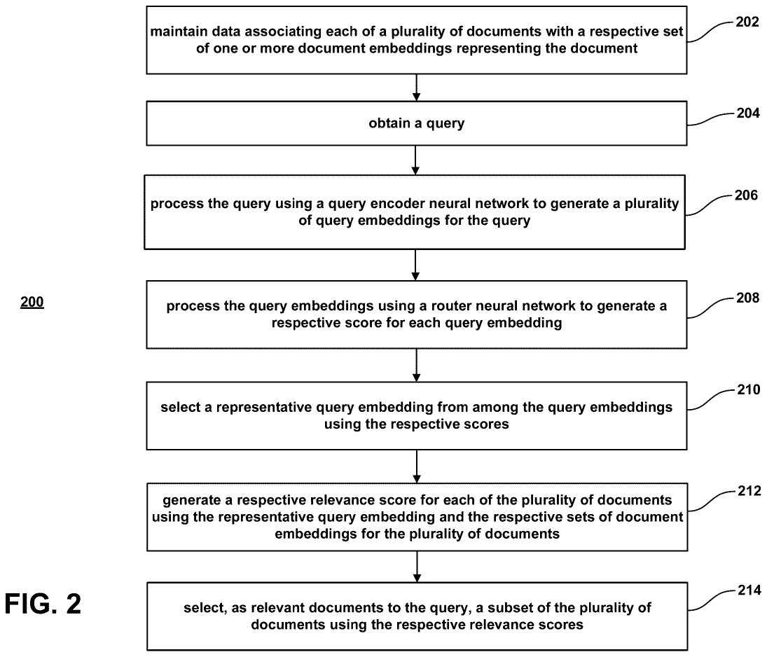

FIG. 2 is a flow diagram of an example process 200 for selecting relevant documents to a query. For convenience, the process 200 will be described as being performed by a system of one or more computers located in one or more locations. For example, an information retrieval system, e.g., the information retrieval system 100 of FIG. 1, appropriately programmed in accordance with this specification, can perform the process 200.

As described above, a query represents the desired document a user seeks and can be represented as, for example, natural language text, an image, a video, audio, or any combination of these.

For example, a query can be the natural language text “Tell me about the artistic influences of the Parthenon in Greece.” or a combination of an image of the Parthenon in Greece along with the query “Tell me about the artistic influences of the Parthenon in Greece.”

As described above, a document can be any appropriate electronic content, for example, text documents, text segments, images, videos, web pages, audio, or any combination of these.

For example, a document can be a web page describing the history of Athens that includes text passages about the Parthenon and images of the structure.

The system maintains data associating each of a plurality of documents with a respective set of one or more document embeddings representing the document (operation 202).

In some cases, the respective set of one or more document embeddings includes a plurality of document embeddings.

For example, if a document contains a sentence of ten words, the set of document embeddings may include ten distinct embeddings, where each embedding corresponds to one of the ten words in the sentence.

As another example, if the document is an image, the set of document embeddings may include multiple embeddings, where each embedding corresponds to a specific patch or region of the image.

In some cases, each document includes a respective plurality of document tokens and the respective set of one or more document embeddings includes a respective document embedding for each document token.

For example, if a document is text, the document can include text token (e.g., words or sub-words) and an embedding vector for each token.

As another example, if the document is an image, the document can include image tokens (e.g., grid of patches of the image which serve as visual tokens) and an embedding vector for each token.

As another example, if the document is multi-modal documents (e.g., a web page containing both text and images), the document can include tokens for each modality (e.g., text tokens and image tokens) and an embedding vector for each token.

In some implementations, the system processes each of the documents using a document encoder neural network to generate the respective set of one or more document embeddings representing the document.

Generally, the document encoder neural network can have any appropriate architecture in any appropriate configuration that processes a document to generate a plurality of document embeddings for the document, including fully connected layers, convolution layers, recurrent layers, attention-based layers, and so on, as is appropriate.

For example, the document encoder neural network can be an encoder-only Transformer architecture. In such implementations, the document encoder neural network processes, for each document, the document into tokens and then generates contextualized embeddings for each document token.

As a particular example, the document encoder neural network can be a BERT-based neural network, such as a 6-layer BERT neural network, which processes, for each document that is text, input text into tokens (e.g., the system uses sub-word tokenization algorithms such as WordPiece, SentencePiece, or Byte-Pair Encoding to tokenize a text document) and then generates contextualized embeddings for each token.

While the previous example describes processing text documents, the system can process documents of various modalities by adapting the tokenization and embedding generation process to the specific data type. Examples now follow.

For image documents, the system can process the image by dividing it into a grid of fixed-size patches (e.g., 16×16 pixels). The system flattens and linearly projects each patch to form a sequence of ‘visual tokens.’ A document encoder, such as a Vision Transformer (ViT) or similar architecture, can then process these patch tokens to generate a corresponding embedding for each patch.

For video documents, the system can extract a sequence of frames at a specific sampling rate. Each frame (or patches within frames) can be treated as a token. Alternatively, the system may extract spatio-temporal tokens using 3D convolutions (e.g., C3D or I3D) that capture both visual appearance and motion over short time clips. The document encoder can then process each token to generate an embedding for each frame or spatio-temporal token.

For audio documents, the system can process audio by converting the raw waveform into a spectrogram (e.g., Log Mel-Spectrogram). The spectrogram is then sliced into time-frequency patches or frames, which serve as tokens. A document encoder (e.g., Wav2Vec or Audio Spectrogram Transformer) can then process these tokens to generate embeddings representing different segments of the audio.

For multimodal documents (e.g., a web page with text and images, or a video with audio), the system can process each stream separately using the respective encoders described above. The system can then concatenate or fuse the resulting embeddings to create a comprehensive set of embeddings representing the multimodal content.

After the system generates these document embeddings, the system can maintain these document embeddings in system maintained memory.

The system obtains a query (operation 204).

The system can receive the query from any appropriate source, such as a client device or an external system. For example, the system can obtain a query submitted by a user interacting with a search engine, a question-answering system, or a recommendation platform.

The system processes the query using a query encoder neural network to generate a plurality of query embeddings for the query (operation 206).

As described above the query encoder neural network can have any appropriate architecture in any appropriate configuration that processes a query to generate a plurality of query embeddings for the query, including fully connected layers, convolution layers, recurrent layers, attention-based layers, and so on, as is appropriate.

For example, the query encoder neural network can be an encoder-only Transformer architecture (e.g., a BERT-based model, such as a 6-layer BERT model), which generates contextualized token-level embeddings for the query (e.g., embeddings for each query token of the query).

In some cases, the query includes a plurality of query tokens and the query embeddings include a respective query embedding for each query token.

For example, if the query is text, the system can tokenize the text into a sequence of tokens (e.g., words or sub-words). The query encoder neural network then can process this sequence of tokens to output a corresponding sequence of embeddings, where each embedding corresponds to a specific token in the sequence rather than a single vector for the entire query.

Similarly, if the query includes images, audio, video, or a combination of these, the system processes these modalities into embeddings using the patch-based, frame-based, or spectrogram-based tokenization methods, for example, as described above with respect to operation 202 in the case of a document encoder neural network processing documents.

The system processes the query embeddings using a router neural network to generate a respective score for each query embedding (operation 208).

The score for each query embedding can be, for example, a logit, a probability, or a scalar value representing the informativeness of the query embedding (e.g., how critical the embedding is for the query-document relationship).

As described above, the router neural network can be any appropriate architecture in any appropriate configuration that processes query embeddings to generate respective scores, including fully connected layers, convolution layers, recurrent layers, attention-based layers, and so on, as is appropriate.

In some cases, to process the query embeddings using a router neural network to generate a respective score for each query embedding, the system processes the query embeddings using one or more self-attention layer blocks to generate a respective updated embedding for each query embedding. Then, the system generates the respective score for each query embedding from the respective updated embeddings.

In some cases, to generate the respective score for each query embedding from the respective updated embeddings, the system, for each query embedding, applies a fully-connected neural network layer to the updated embedding for the query embedding to generate an initial score for the query embedding.

As an example, the router neural network can include a self-attention layer followed by a dense layer (e.g., a fully-connected neural network layer). The router neural network can apply a self-attention mechanism to the query embeddings to compute the relative importance of each embedding based on pairwise interactions, and then pass the resulting representations through a dense layer to generate score (e.g., a logit value) for each embedding.

The system selects a representative query embedding from among the query embeddings using the respective scores (operation 210). That is, the system selects a representative query embedding from the plurality of query embeddings generated by the query encoder neural network (e.g., the output of operation 206) using the respective scores.

The representative query embedding can be the single query embedding that is determined to be the most informative or relevant for retrieving documents.

In some cases, the system selects, as the representative query embedding, the query embedding associated with the largest score.

For example, if the query consists of token embeddings with respective router scores of 0.2, 0.9, and 0.4, the system identifies 0.9 as the largest score and selects the embedding corresponding to that score as the representative query embedding.

The system generates a respective relevance score for each of the plurality of documents using the representative query embedding and the respective sets of document embeddings for the plurality of documents (operation 212). The relevance score represents how well the document satisfies the information need represented by the query.

In some implementations, to generate a respective relevance score for each of the plurality of documents, the system, for each document, sets the relevance score for the document to the greatest similarity measure value between the representative query embedding and any of the document embeddings that are in the set of documents embeddings for the document.

The similarity measure can be any measure that quantifies the similarity between two embeddings. In some cases, the similarity measure is the cosine similarity. Other examples of similarity measures include the dot product or Euclidean distance.

As an example of operation 212, if a document is represented by three embeddings, the system calculates the cosine similarity measure value between the representative query embedding and each of the three document embeddings. Then, the system sets the relevance score for that document as the highest similarity measure value (e.g., the highest cosine similarity score, which correspond to the document embedding whose direction most aligns with the representative query embedding's direction).

In some other implementations, to generate a respective relevance score for each of the plurality of documents, the system, for each document, sets the relevance score for the document to an average (mean) of the similarity measure values, a sum of the similarity measure values, or an aggregation of a subset of the highest similarity measure values (e.g., an average of the top-k similarity scores) between the representative query embedding and the document embeddings that are in the set of document embeddings for the document.

The system selects, as relevant documents to the query, a subset of the plurality of documents using the respective relevance scores (operation 214).

In some implementations, the system selects the documents with the highest respective relevance scores. For example, the system can rank the documents in descending order based on their scores and select a predetermined number of the top-ranked documents (e.g., the top 10 or top 100 documents).

In other implementations, the system uses a threshold value to determine the subset. For example, the system can compare each document's relevance score to a minimum relevance threshold and select only those documents whose scores exceed the threshold, ensuring that all returned documents meet a specific baseline of relevance regardless of the total number of documents selected.

In yet other implementations, the system selects the subset of documents using importance sampling based on the relevance scores. For example, the system can normalize the relevance scores to form a probability distribution (e.g., using a softmax function) and sample the subset of documents from the plurality of documents based on this distribution, such that documents with higher relevance scores have a proportionately higher probability of being selected for the subset.

As described above, prior to using the system to select the documents, the system or another training system can train the query encoder neural network, the document encoder neural network, and the router neural network.

Further details of training the query encoder neural network, the router neural network, and the document encoder neural network jointly are described below.

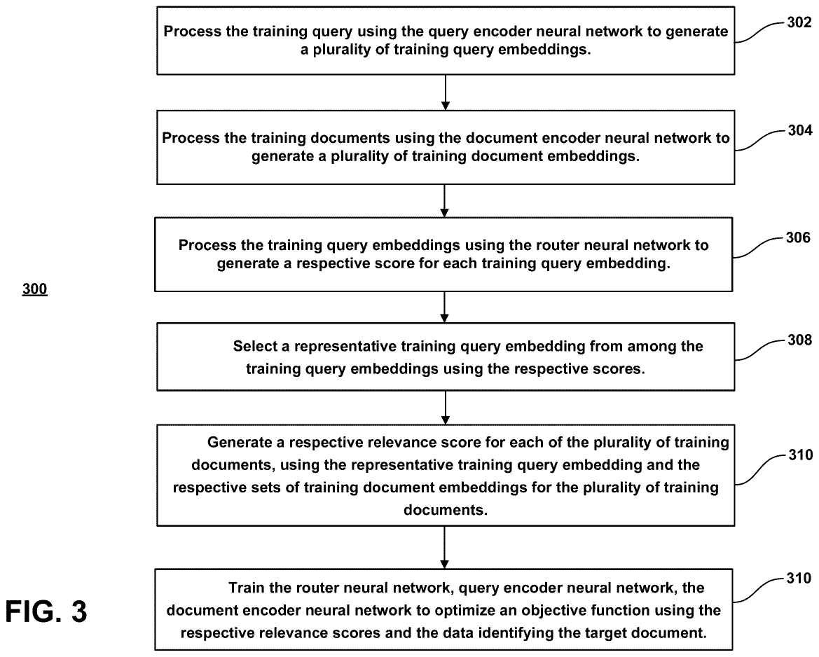

FIG. 3 is a flow diagram of an example process 300 for jointly training a router neural network, query encoder neural network, and document encoder neural network. For convenience, the process 300 will be described as being performed by a system of one or more computers located in one or more locations. For example, an information retrieval system, e.g., the information retrieval system 100 of FIG. 1, appropriately programmed in accordance with this specification, can perform the process 300.

To perform process 300, the system obtains training data that includes training examples. The system can obtain the training data from system-maintained data, a user, or another system through any of a variety of methods.

In some implementations, the query encoder neural network, the router neural network, and the document encoder neural network are trained jointly on a training data set that includes a plurality of training examples that each include a training query, a plurality of training documents, and data identifying one or more target documents from the plurality of training documents. That is, the training data can include a collection of queries and documents, where each training example can include a training query, one or more positive (target) training documents, and one or more negative (non-target) training documents.

The system or another training system repeatedly updates the trainable parameters of the router neural network, query encoder neural network, and document encoder neural network using the training data. That is, the system can repeatedly perform the following described example process using training examples to repeatedly update the trainable parameters of these networks from scratch, i.e., train from randomly initialized parameters, or to fine-tune, i.e., further update previously determined parameters.

The system processes the training query using the query encoder neural network to generate a plurality of training query embeddings (operation 302).

The system can process the training query using the query encoder neural network in the same manner as the system processes a query during inference described above. That is, the query encoder neural network processes the training query (e.g., natural language text) to generate a sequence of embeddings, where each embedding can correspond to a token in the training query.

The system processes the training documents using the document encoder neural network to generate a plurality of training document embeddings (operation 304).

The system can process each of the training documents using the document encoder neural network in the same manner as the system processes a document to generate document embeddings for the maintained data described above. That is, the document encoder neural network processes each training document to generate a respective set of one or more embeddings representing that training document.

The system processes the training query embeddings using the router neural network to generate a respective score for each training query embedding (operation 306).

The system can process the training query embeddings using the router neural network in the same manner as the system processes query embeddings during inference described above.

The system selects a representative training query embedding from among the training query embeddings using the respective scores (operation 308).

Unlike the inference process, which may select the training query embedding with the corresponding largest score, the training process can utilize a differentiable selection mechanism to ensure that later gradients can backpropagate through this selection operation to update the router and encoder networks.

In some implementations, to select a representative training query embedding from among the training query embeddings using the respective scores, the system adds Gumbel noise to the respective scores to generate perturbed scores. The system then generates a respective final score for each training query, which includes updating the perturbed scores by applying a temperature softmax function to the perturbed scores. Then, the system selects the query embedding associated with a largest final score.

For example, the system can generate noise samples from a Gumbel distribution (e.g., by transforming samples from a uniform distribution) and add this noise to the query embedding scores (e.g., logits). The system then processes these perturbed scores through a softmax function controlled by a temperature parameter to generate respective final scores for each training query. To account for the fact that selecting a query embedding associated with a particular final score is a non-differentiable discrete operation, the system can utilize a straight-through estimator (STE), as described above. The STE allows the system to select a representative embedding during the forward pass while propagating gradients through the continuous output of the softmax function during the backward pass, thereby maintaining the flow of gradients for training.

As a particular example, for each query embedding (index as i), the system generates independent and identically distributed (i.i.d.) samples uᵢ from a Uniform distribution Uniform(0,1). The system then computes the Gumbel noise gᵢ as gᵢ=−log(−log (uᵢ)). The system adds this noise to the query embedding scores (e.g., logits) αᵢ and applies a softmax function with a temperature t. The resulting final score yᵢ is calculated as:

$${y}_{i} = \frac{exp ( ( log ( {α}_{i} ) + {g}_{i} ) / τ )}{{\sum }_{j} exp ( ( log ( {α}_{j} ) + {g}_{j} ) / τ )}$$

As the temperature τ approaches zero, the distribution y approaches a one-hot vector (approximating an argmax), effectively selecting a single embedding while maintaining differentiability with respect to the router parameters.

In some cases, to generate the respective final score for each training query, the system applies a masking to the perturbed scores prior to applying the temperature softmax function.

For example, the system can apply a masking mechanism to the perturbed scores prior to applying the temperature softmax function to ensure the router neural network explores selecting different query embeddings during training. The system may define a binary mask mᵢ∈{0,1}, where a value of 1 indicates the corresponding query embedding should be masked out. The mask may be determined based on the magnitude of the (perturbed) query embedding scores (e.g., masking scores that fall below a threshold).

In some cases, the system updates the perturbed scores αᵢ using the mask and a small constant ∈ (epsilon). For example, the system may update the perturbed scores according to the equation: αᵢ=αᵢ·(1−mᵢ)+∈. In some implementations, ∈ is set to a small value (e.g., 0.05). This formulation ensures that even masked query embeddings retain a non-zero probability of selection after the temperature softmax function is applied, encouraging the router neural network to explore different query embeddings during the training process.

The system generates a respective relevance score for each of the plurality of training documents, using the representative training query embedding and the respective sets of training document embeddings for the plurality of training documents (operation 310).

The system can generate the respective relevance score for each training document in the same manner as described above. That is, for each training document, the system calculates the similarity measures between the representative training query embedding and each of the training document embeddings for that training document. The system can then identify the highest similarity measure for that document and assign it as the relevance score. The system performs this process for both the target (positive) documents and the non-target (negative) documents included in the training example.

The system trains the router neural network, query encoder neural network, the document encoder neural network to optimize an objective function using the respective relevance scores and the data identifying the target document (operation 312).

Generally, the objective function compares the relevance scores of the target documents against the relevance scores of the non-target documents. The system can compute a loss based on these comparisons to encourage the router neural network, query encoder neural network, and document encoder neural network to collectively cause a higher relevance score assignment to target documents and lower scores to non-target documents.

Some examples of objective functions include the InfoNCE (Information Noise Contrastive Estimation) loss, negative log-likelihood (NLL) loss or a cross-entropy loss applied to the relevance scores.

The system can update the trainable parameters of the networks to optimize the objective function in any variety of ways. For example, the system can optimize the objective using gradient descent techniques that include the use of a backpropagation technique. To facilitate backpropagation through the discrete selection process of operation 308, the system can utilize a straight-through estimator (STE) described above. Using the STE, the system treats the hard one-hot vectors selected during the forward pass as continuous during the backward pass, allowing gradients to propagate through the Gumbel-softmax function to the router and encoder networks.

Generally, the system repeats the above steps until one or more criteria are satisfied (e.g., the system performs a pre-determined number of iterations or until the loss converges).

Although the above description describes jointly training the router neural network, query encoder neural network, and document encoder neural network, in some cases, the system can freeze one or more of these networks while training the others. For example, the system may freeze the weights of the query and document encoder neural networks and only update the parameters of the router neural network to learn the optimal selection policy without modifying the underlying embedding space. Alternatively, the system may fine-tune all three networks simultaneously to adapt both the representations and the routing mechanism to the specific retrieval task.

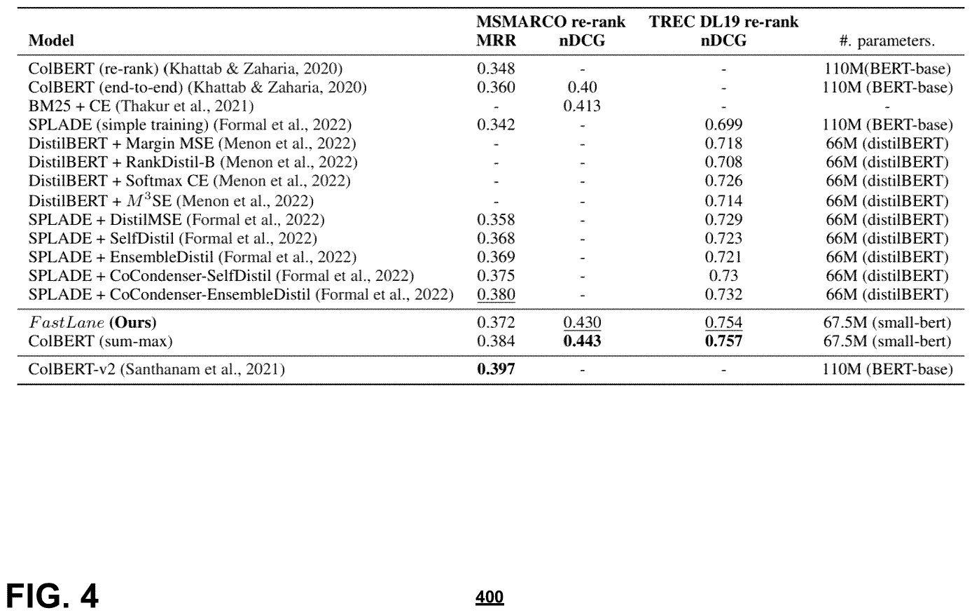

FIG. 4 is an example 400 of the performance of the described techniques.

In particular, example 400 is a table that shows the comparative performance of the described techniques (labeled as “FastLane (Ours)”) against other techniques such as ColBERT, BM25, and SPLADE, listed as rows. The columns of the table display performance metrics, specifically Mean Reciprocal Rank (MRR) and Normalized Discounted Cumulative Gain (nDCG), on datasets (MSMARCO and TREC DL19), as well as the number of trainable parameters associated with each technique.

Example 400 shows that by utilizing a router neural network to select a single representative query embedding, the described techniques achieve competitive or superior performance relative to other dense and sparse retrieval techniques.

Additionally, example 400 shows that the described techniques achieve high retrieval effectiveness (i.e., identifies relevant documents for queries well) while utilizing fewer parameters compared to other techniques. That is, the described techniques' query encoder neural network, document encoder neural network, and router neural network cumulatively include fewer parameters than the other techniques yet result in comparable or higher performance. This result validates that jointly training the router neural network, query encoder neural network, and document encoder neural network to optimize an objective function yields a more computationally efficient system, as it requires fewer parameters than other techniques to achieve these results.

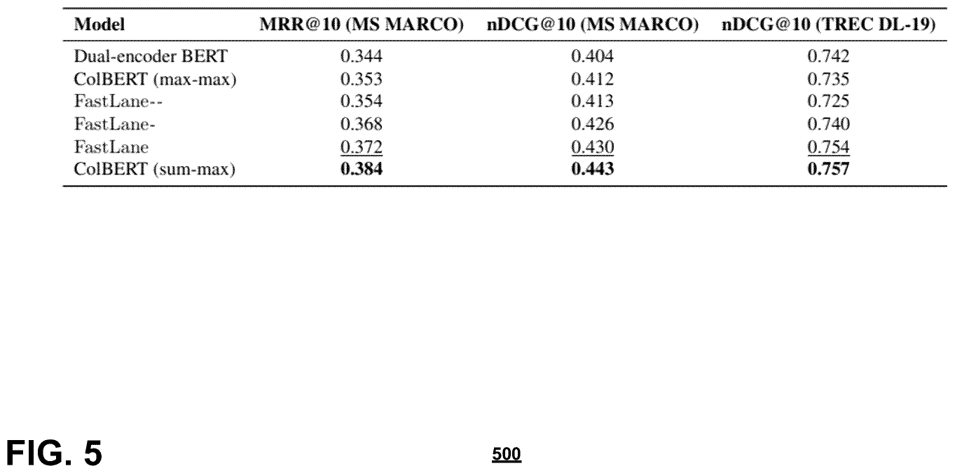

FIG. 5 is another example 500 of the performance of the described techniques.

In particular, example 500 is a table that shows the comparative performance of the described techniques (labeled as “FastLane”) against varying subsets of the described techniques (labeled “FastLane--” and “FastLane-”) and other techniques such as Dual-encoder BERT and ColBERT. The label “FastLane-” corresponds to an implementation of the information retrieval system where the regularization masking during training is omitted, while “FastLane--” corresponds to an implementation where both the regularization masking and the Gumbel-Softmax reparameterization trick are omitted (or replaced with a standard non-differentiable selection). The columns display performance metrics including Mean Reciprocal Rank at 10 (MRR@10) and Normalized Discounted Cumulative Gain at 10 (nDCG@10) across the MS MARCO and TREC DL-19 datasets.

Example 500 shows that the full implementation of the described techniques (FastLane) achieves superior performance metrics (e.g., 0.372 MRR@10) compared to the ablated versions (FastLane-- and FastLane-) and the standard Dual-encoder BERT (0.344 MRR@10). This validates that the specific configuration of the router neural network to select a representative query embedding using the Gumbel-softmax trick and regularization during training (as described in operation 308 above) maximizes retrieval effectiveness. It demonstrates that the described techniques' mechanism for selecting a single representative query capture more precise semantic information than other approaches, resulting in higher relevance scores for the target documents.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
maintaining data associating each of a plurality of documents with a respective set of one or more document embeddings representing the document;
obtaining a query;
processing the query using a query encoder neural network to generate a plurality of query embeddings for the query;
processing the query embeddings using a router neural network to generate a respective score for each query embedding;
selecting a representative query embedding from among the query embeddings using the respective scores;
generating a respective relevance score for each of the plurality of documents using the representative query embedding and the respective sets of document embeddings for the plurality of documents; and
selecting, as relevant documents to the query, a subset of the plurality of documents using the respective relevance scores.

2. The method of claim 1, wherein selecting the representative query embedding from among the query embeddings using the respective scores comprises:
selecting, as the representative query embedding, the query embedding associated with the largest score.

3. The method of claim 1, wherein selecting the representative query embedding from among the query embeddings using the respective scores comprises:
adding Gumbel noise to the respective scores;
updating the respective scores by applying a temperature softmax function; and
selecting, as the representative query embedding, the query embedding associated with the largest score.

4. The method of claim 1, wherein generating a respective relevance score for each of the plurality of documents comprises, for each document:
setting the relevance score for the document to the greatest similarity measure value between the representative query embedding and any of the document embeddings that are in the set of documents embeddings for the document.

5. The method of claim 1, wherein the similarity measure is the cosine similarity.

6. The method of claim 1, wherein processing the query embeddings using a router neural network to generate a respective score for each query embedding comprises:
processing the query embeddings using one or more self-attention layer blocks to generate a respective updated embedding for each query embedding; and
generating the respective score for each query embedding from the respective updated embeddings.

7. The method of claim 6, wherein generating the respective score for each query embedding from the respective updated embeddings comprises:
for each query embedding, applying a fully-connected neural network layer to the updated embedding for the query embedding to generate an initial score for the query embedding.

8. The method of claim 1, further comprising processing each of the documents using a document encoder neural network to generate the respective set of one or more document embeddings representing the document.

9. The method of claim 1, wherein the respective set of one or more document embeddings comprises a plurality of document embeddings.

10. The method of claim 9, wherein each document comprises a respective plurality of document tokens and wherein the respective set of one or more document embeddings comprises a respective document embedding for each document token.

11. The method of claim 1, wherein the query comprises a respective plurality of query tokens and wherein the query embeddings comprise a respective query embedding for each query token.

12. The method of claim 1, when dependent on claim 8, wherein the query encoder neural network, the router neural network, and the document encoder neural network have been trained jointly on a training data set comprising a plurality of training examples that each comprise a training query, a plurality of training documents, and data identifying one or more target documents from the plurality of training documents.

13. The method of claim 12, wherein the joint training comprises, for each training example:
processing the training query using the query encoder neural network to generate a plurality of training query embeddings;
processing the training documents using the document encoder neural network to generate a plurality of training document embeddings;
processing the training query embeddings using the router neural network to generate a respective score for each training query embedding;
selecting a representative training query embedding from among the training query embeddings using the respective scores;
generating a respective relevance score for each of the plurality of training documents, using the representative training query embedding and the respective sets of training document embeddings for the plurality of training documents; and
training the router neural network, query encoder neural network, the document encoder neural network to optimize an objective function using the respective relevance scores and the data identifying the target document.

14. The method of claim 13, wherein selecting a representative training query embedding from among the training query embeddings using the respective scores comprises:
adding Gumbel noise to the respective scores to generate perturbed scores;
generating a respective final score for each training query, comprising updating the perturbed scores by applying a temperature softmax function to the perturbed scores; and
selecting the query embedding associated with a largest final score.

15. The method of claim 14, wherein generating the respective final score for each training query further comprises:
applying a masking to the perturbed scores prior to applying the temperature softmax function.

16. A system comprising:
one or more computers; and
one or more storage devices communicatively coupled to the one or more computers, wherein the one or more storage devices store instructions that, when executed by the one or more computers, cause the one or more computers to perform the operations, the operations comprising:
maintaining data associating each of a plurality of documents with a respective set of one or more document embeddings representing the document;
obtaining a query;
processing the query using a query encoder neural network to generate a plurality of query embeddings for the query;
processing the query embeddings using a router neural network to generate a respective score for each query embedding;
selecting a representative query embedding from among the query embeddings using the respective scores;
generating a respective relevance score for each of the plurality of documents using the representative query embedding and the respective sets of document embeddings for the plurality of documents; and
selecting, as relevant documents to the query, a subset of the plurality of documents using the respective relevance scores.

17. The system of claim 16, wherein selecting the representative query embedding from among the query embeddings using the respective scores comprises:
selecting, as the representative query embedding, the query embedding associated with the largest score.

18. The system of claim 16, wherein selecting the representative query embedding from among the query embeddings using the respective scores comprises:
adding Gumbel noise to the respective scores;
updating the respective scores by applying a temperature softmax function; and
selecting, as the representative query embedding, the query embedding associated with the largest score.

19. The system of claim 16, wherein generating a respective relevance score for each of the plurality of documents comprises, for each document:
setting the relevance score for the document to the greatest similarity measure value between the representative query embedding and any of the document embeddings that are in the set of documents embeddings for the document.

20. One or more non-transitory computer storage media storing instructions that when executed by one or more computers cause the one or more computers to perform the operations, the operations comprising:
maintaining data associating each of a plurality of documents with a respective set of one or more document embeddings representing the document;
obtaining a query;
processing the query using a query encoder neural network to generate a plurality of query embeddings for the query;
processing the query embeddings using a router neural network to generate a respective score for each query embedding;
selecting a representative query embedding from among the query embeddings using the respective scores;
generating a respective relevance score for each of the plurality of documents using the representative query embedding and the respective sets of document embeddings for the plurality of documents; and
selecting, as relevant documents to the query, a subset of the plurality of documents using the respective relevance scores.
